(19) United States
(12) Patent Application Publication
(10) Pub. No.: US 2011/0016995 A1
(43) Pub. Date: Jan. 27, 2011

(54) MODULE OR TOOL CHANGING FOR METROLOGICAL PROBE

(75) Inventors: David R. McMurtry, Wotton-under-Edge (GB); Geoffrey McFarland, Wotton-under-Edge (GB)

Correspondence Address: OLIFF & BERRIDGE, PLC, P.O. BOX 320850, ALEXANDRIA, VA, 22320-4850, US

(73) Assignee: RENISHAW PLC, Wotton-under-Edge, Gloucestershire (GB)

(21) Appl. No.: 12/674,793

(22) PCT Filed: Sep. 15, 2008
(86) PCT No.: PCT/GB2008/003099

§ 371 Date: Feb. 23, 2010

(30) Foreign Application Priority Data
Sep. 14, 2007 (GB) 0717969.0

(51) Int. Cl. G01D 15/00

(52) U.S. Cl. 73/866.5

(57) ABSTRACT

Apparatus is disclosed for changing task modules or styli of a metrological probe. In one embodiment, a stylus module (18) is retained magnetically on a retaining module (16) of the probe. A horizontal pin (38) extends from a storage device (32) and engages in an aperture (40) in the stylus module (18). This allows the stylus module to be separated by a vertical movement of the retaining module. To control tilting of the stylus module relative to the retaining module, the pin (38) extends up to or beyond the resultant vector of the magnetic coupling force between the stylus module and the retaining module, which in this embodiment is along the centre line (42) of the stylus module.

The present invention relates to apparatus for changing modules and other tools of a metrological probe. In particular, the invention relates to apparatus for changing the modules or tools of a probe using movement of the machine on which the probe is mounted. The machine is typically a coordinate positioning apparatus such as coordinate measuring machines (CMM), machine tools, manual co-ordinate measuring arms and the like. The module or tool may be a stylus module or stylus of the probe.

Our earlier European patent EP 0566719 discloses a touch probe comprising a retaining module (such as a sensing module) and a task module (such as a stylus module). The task module is releasably mounted in a repeatable position on the retaining module via kinematic engagement elements on the two modules, which are held together magnetically. A magazine comprising a plurality of storage ports is provided for the housing of task modules. The storage ports each comprise a base with a pair of jaws, the jaws having parallel docking inserts.

The probe may be mounted on the quill of a machine which transports the probe to the storage port into which the task module is inserted. The task module has a circular lip, the upper edge of which abuts the lower surfaces of the docking inserts.

The task module is separated from the retaining module by upwards movement of the quill. As the task module is retained by the storage port, this acts against the magnetic force and breaks the contact between the modules.

Such a magazine and task modules enable engagement of a task module by a retaining module, and disengagement of the task module from the storage port in a single continuous movement and without any additional machine apparatus (such as dedicated motors or electromagnets).

U.S. Pat. No. 7,024,783 discloses a storage port for separating a magnetically coupled task module from a modular probe. An arm of the storage port engages with the task module and is rotatable about a pivot such that on moving the probe upwards, the task module is also pulled upwards causing the arm and hence the task module to rotate about the pivot and thus breaking contact between the task module and the probe with a tilting action.

European Patent Application EP1669713 discloses a further storage port for separating a magnetically coupled stylus from a probe. The port has a pin, which engages in a hole in the stylus. This retains the stylus in the port against upward movement of the probe. The upward movement causes tilting of the stylus in the port.

If there is a large magnetic force between the modules, or between the stylus and the probe, the quill of the machine may not be able to apply sufficient force to separate them, or may suffer adverse effects from applying sufficient force. Such tilting of the task module or stylus may then be advantageous to reduce the force between them, so as to match a suitable force applied by the quill. However where the quill is able to apply sufficient force, it is advantageous to pull the modules (or the stylus and the probe) apart squarely.

Even in EP 0566719, the use of a pair of jaws in the storage port results in two or more areas of contact between the storage port and the task module (i.e. each jaw and the task module). It is almost impossible due to manufacturing tolerances to ensure the two jaws are level. Thus there will be some tilting of the task module on engagement and pull off with the retaining module. Tilting has the disadvantage of causing sliding on the kinematic engagement elements. Excessive sliding can cause wear and debris, causing the kinematic engagement elements to require cleaning.

The present invention provides apparatus as set out in the claims. In some embodiments, this reduces or prevents tilting of the task module or tool. In others, it controls such tilting in desirable ways. For example, if the retaining module or probe is not perfectly aligned with the storage device, it may allow tilting relative to the storage device so as to reduce the tilting relative to the retaining module or probe.

Preferred embodiments of the invention will now be described with reference to the following drawings:

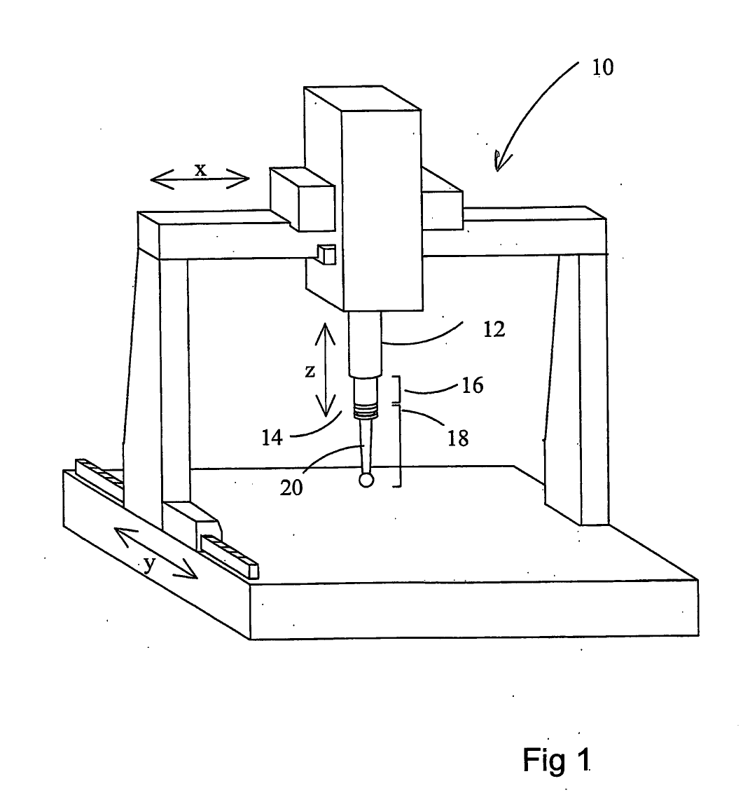

FIG. 1 illustrates a modular probe mounted on a CMM;

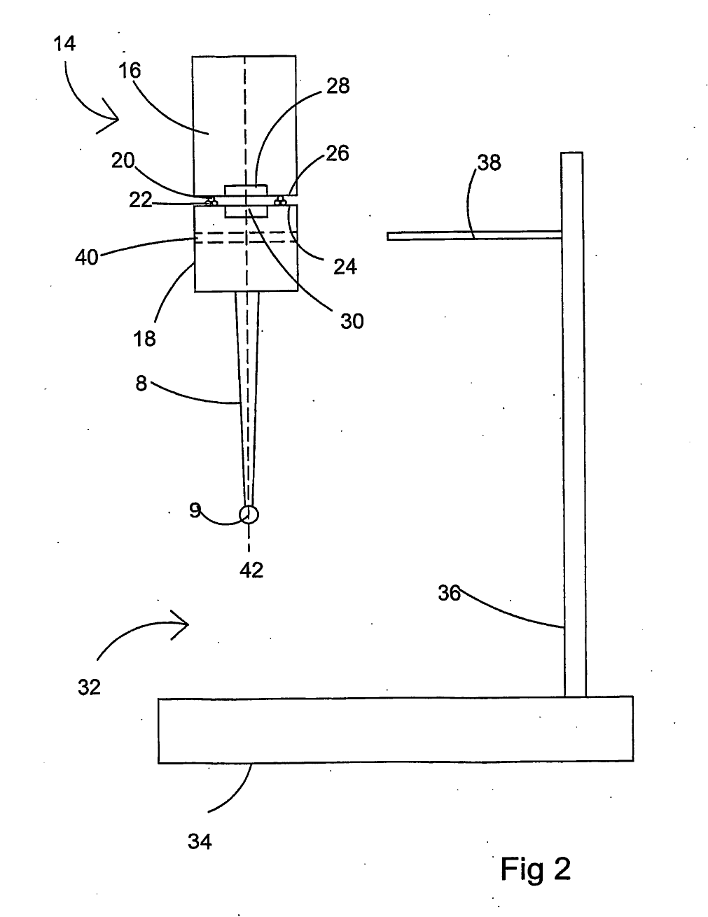

FIG. 2 is a side view of a modular probe adjacent a storage port;

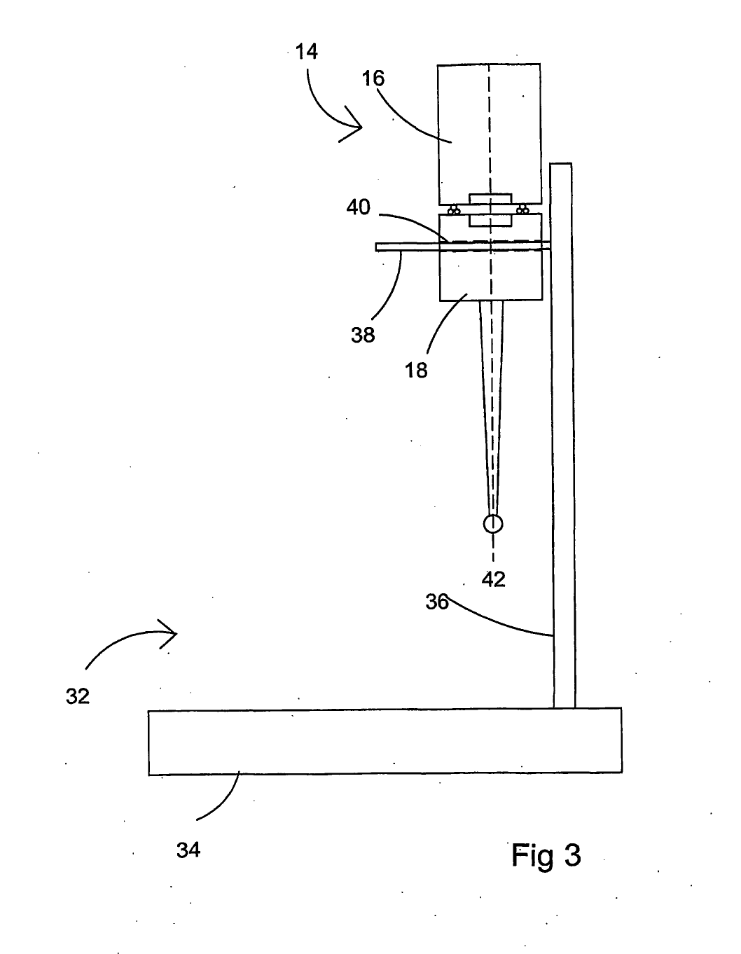

FIG. 3 is a side view of a modular probe engaged with a storage port;

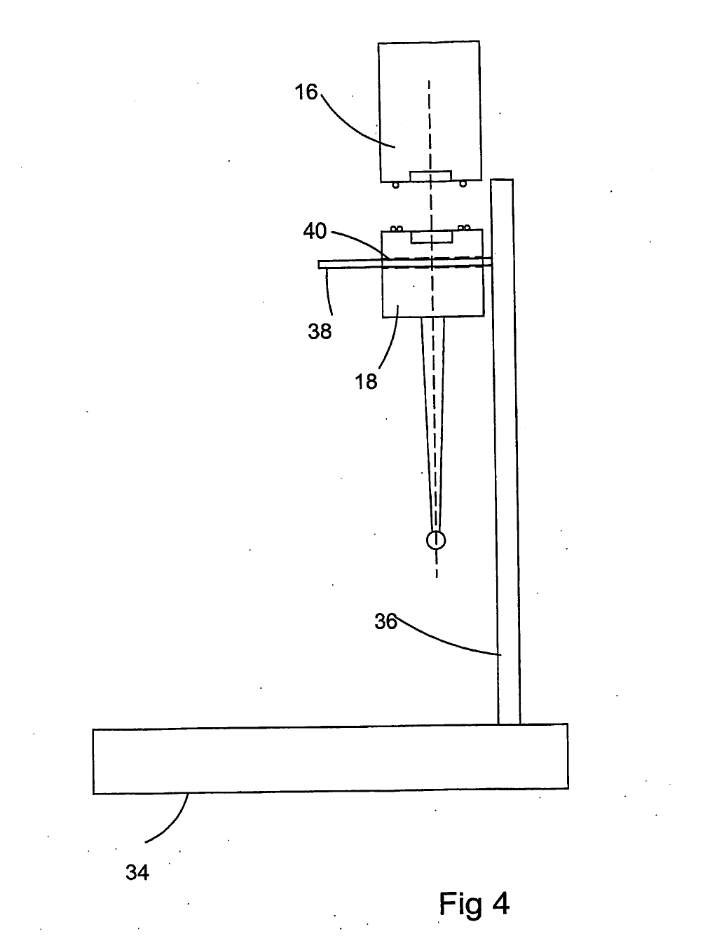

FIG. 4 is a side view of a task module engaged with a storage port, the task module being disengaged with a retaining module of a modular probe;

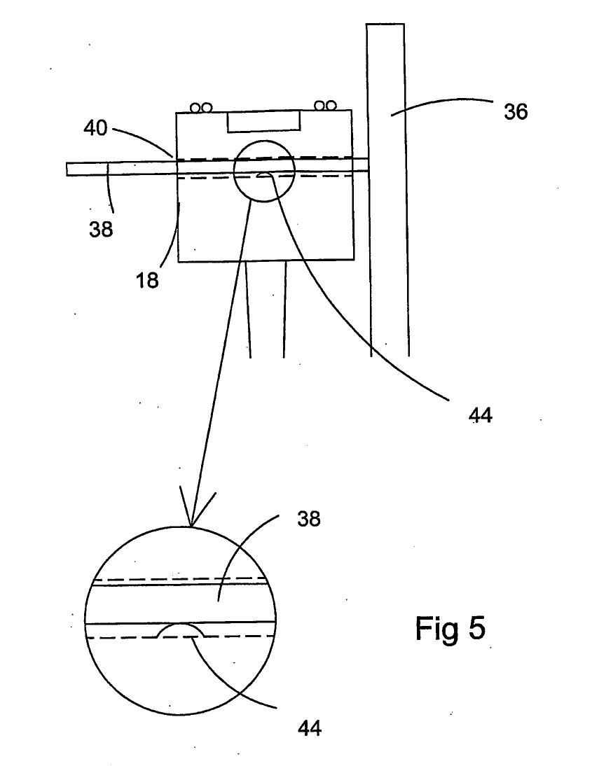

FIG. 5 shows details of a task module engaged with a storage port, showing a protrusion on the task module;

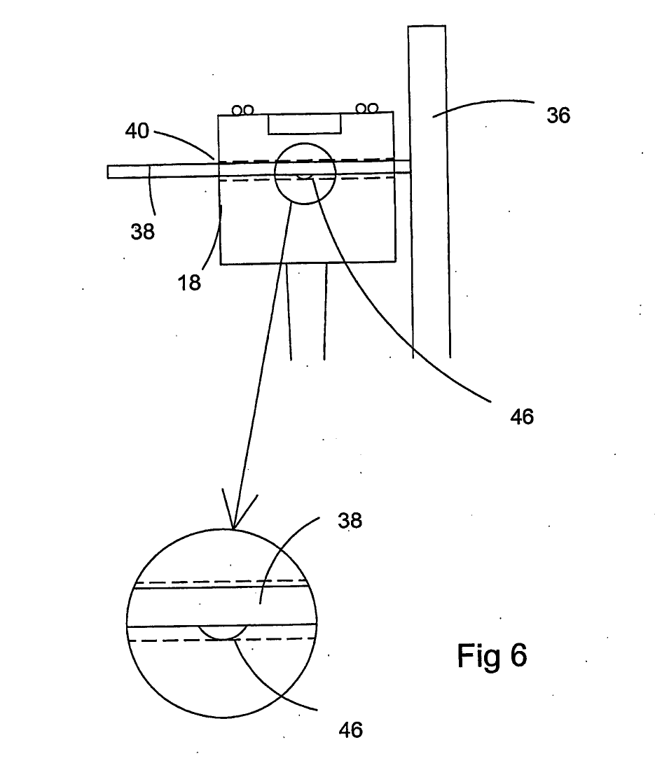

FIG. 6 shows details of a task module engaged with a storage port, showing a protrusion on the engagement member of the storage port;

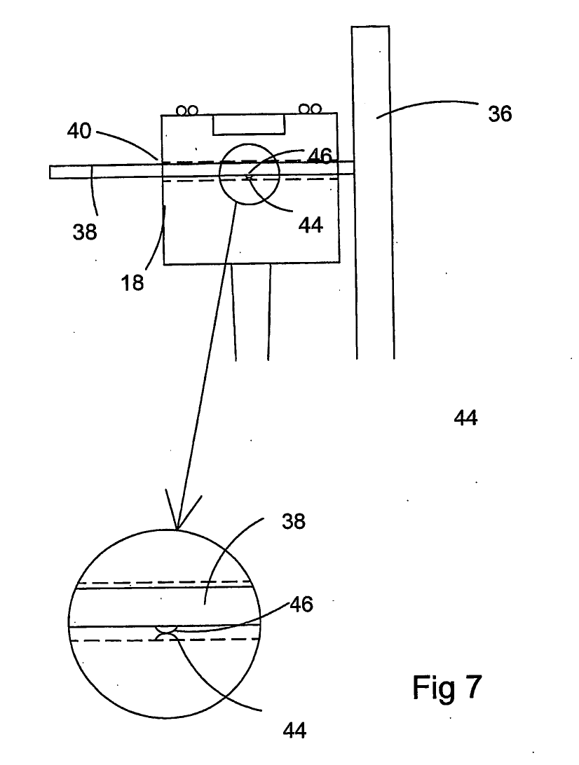

FIG. 7 shows details of a task module engaged with a storage port, showing protrusions on both the task module and the engagement member of the storage port;

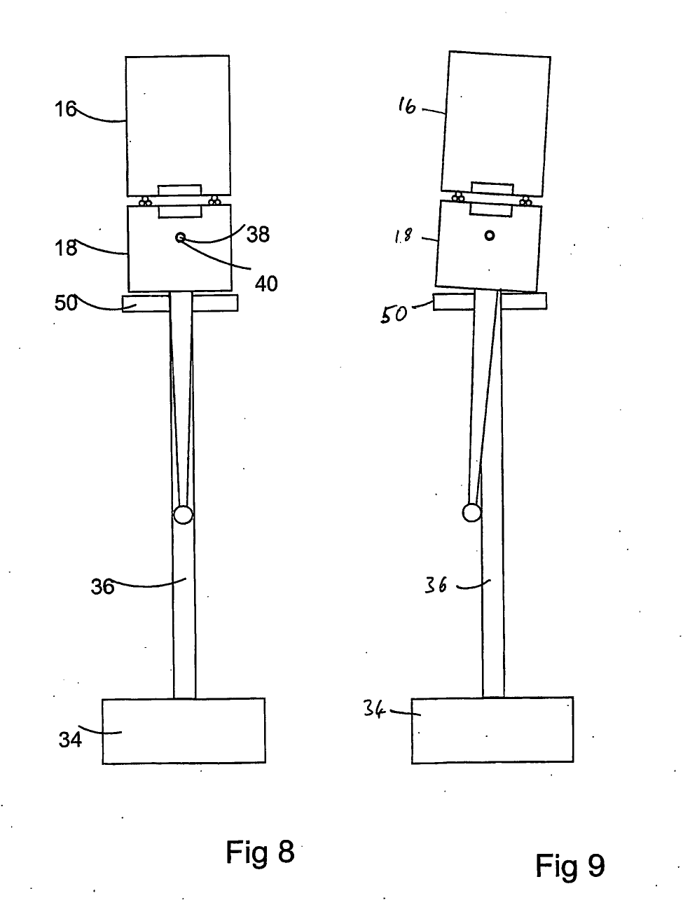

FIGS. 8&9 illustrate an embodiment of the storage port which includes retaining means to limit rotation of the task module held in the storage port;

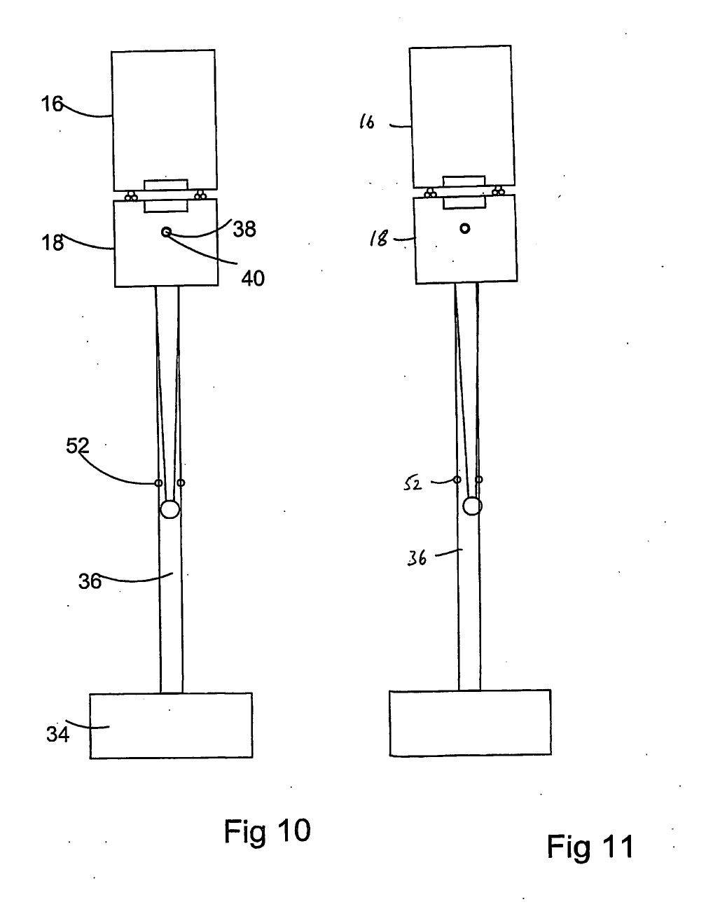

FIGS. 10&11 illustrate an alternative embodiment of the storage port which includes retaining means to limit rotation of the task module held in the storage port;

FIG. 12 shows details of the task module engaged in the storage port, in which both the engagement member and aperture have square cross sections;

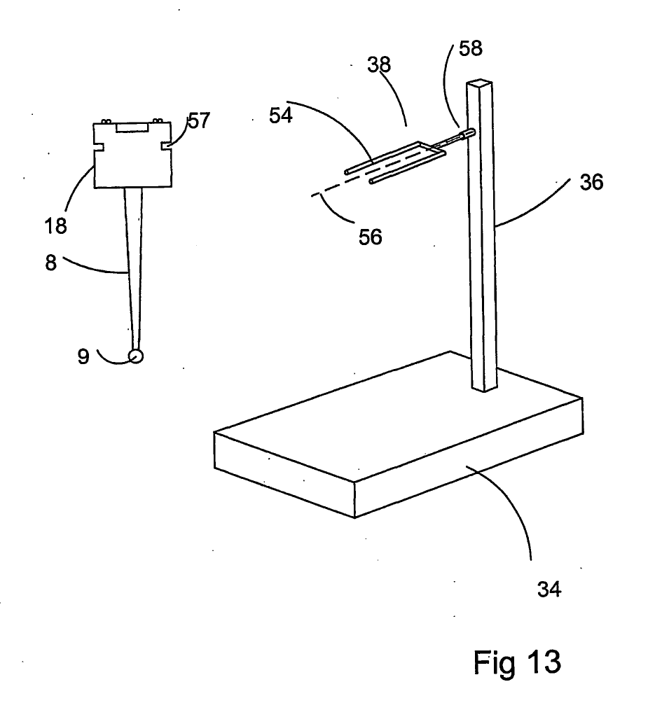

FIG. 13 shows an embodiment of the storage port in which the engagement member is forked and rotatable;

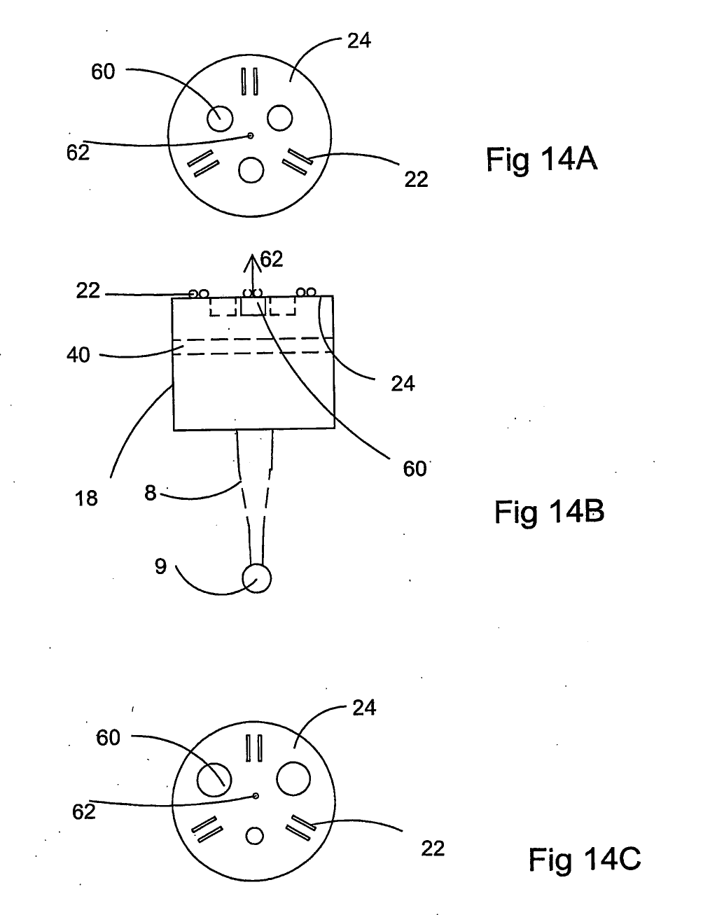

FIGS. 14A-C illustrate the arrangement of magnets on the task module;

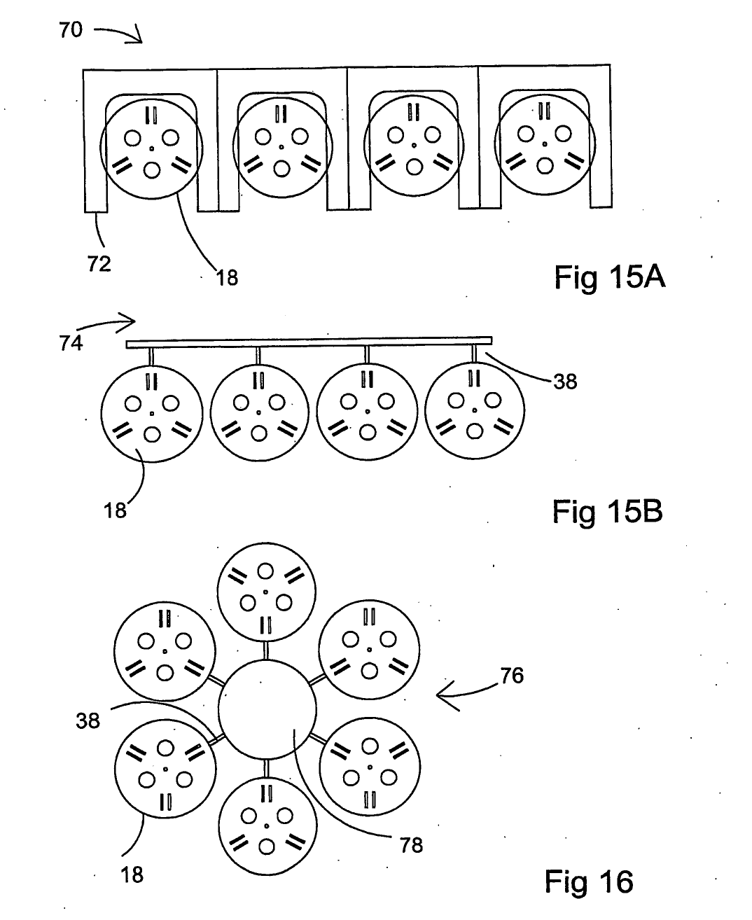

FIGS. 15A and 15B are plan views of task modules stored in magazines according to the prior art and present invention respectively;

FIG. 16 is a plan view of a carousel for storing task modules according to the present invention; and

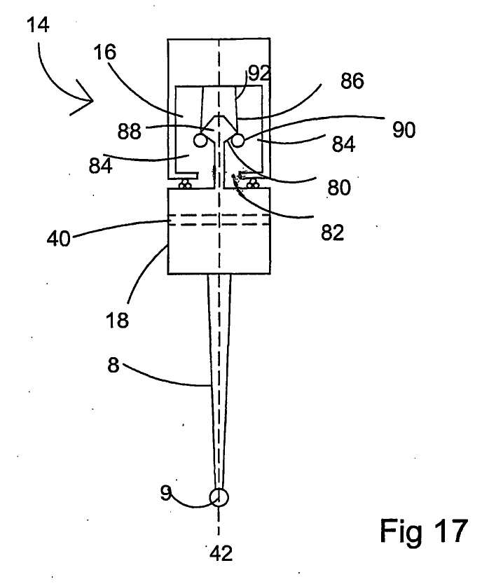

FIG. 17 illustrates a mechanical coupling between a task module and a retaining module.

FIG. 1 shows a coordinate measuring machine (CMM) 10 in which a quill 12 may be moved in X, Y and Z by motors on the CMM (not shown). A modular measurement probe 14 is mounted on the quill 12 and comprises a retaining module 16 which is attached to the quill 12 of the CMM and a task module 18 which is releasably mounted on the retaining module 16. The retaining module may comprise a sensing module which houses the sensing mechanism of the probe and the task module may comprise a stylus module. The retaining module may also comprise a probe head, which may for example cause rotation about one or more axes, and the task module may comprise a probe.

The position of the task module 18 on the retaining module 16 is defined by engagement between a set of cooperating elements on an upper surface of the task module with a set of cooperating elements on a lower surface of the retaining module 16. These cooperating elements may comprise, for example, three cylindrical rollers spaced at 120° about the longitudinal axis of the probe on one of the modules engageable with three pairs of balls similarly spaced on the other of the modules. This forms a kinematic mount such that the position of the task module 18 on the retaining module 16 is repeatable. The respective sets of cooperating elements are held in engagement by the attraction between magnets provided on both the retaining and task modules. A suitable arrangement of cooperating elements is disclosed in our earlier European patents EP 0566719 and EP 0501710, which are incorporated herein by reference. Of course, rather than magnets on both the retaining and task modules, it is possible to provide a magnet on only one of them, cooperating with an element on the other which is made of a magnetically attractive material such as iron.

The modular construction of the probe enables automatic exchange of task modules, for example styli modules. To provide a truly flexible measuring system, a plurality of task modules must be retained within the working area of the machine to enable automatic exchange of one task module for another.

A storage port is provided on the CMM to house a task module. Several storage ports may be accommodated together in a magazine. A task module housed in a storage port may be picked up by the retaining module or a task module may be deposited into an empty storage port by the retaining module. In this manner the probe may exchange task modules so that it uses the most suitable one for the task in hand.

The storage port will now be described with reference to FIGS. 2-13.

FIG. 2 illustrates a first embodiment of the storage port of the present invention. The storage port 32 comprises a base 34, a support 36 which extends vertically from the base and an engagement member 38 extending horizontally from the support. The engagement member has an engagement portion for engagement with the task module. This may comprise all or part of the engagement region.

A simplified modular probe 14 is also illustrated which comprises a retaining module 16 and a task module 18. The retaining module 16 is mountable onto the quill of the CMM (or other coordinate positioning apparatus) or other probe module. In the embodiment illustrated in FIG. 2, the task module 18 is a stylus module and includes a deflectable stylus 8 with a workpiece contacting tip 9. The retaining module 16 and task module 18 have cooperating sets of engagement elements 20,22 on their cooperating faces 24,26 which when mutually engaged define the position of the task module 18 with respect to the retaining module 16.

The task module 18 is magnetically retained on the retaining module by magnets 28,30 in both the task module and retaining module. Each module may be provided with one or more magnets on a surface which cooperates with the other module. The magnets cause a force which holds the task module to the retaining module. FIGS. 14A & 14B illustrate the plan and side views respectively of the task module, showing the position of three magnets 60. The position of the resultant vector of the force 62 caused by these magnets 60 is shown. FIG. 14C is a plan view of the top of the task module in which the magnets are not evenly distributed about the centreline of the task module. In this case the position of the vector of the resultant force is off centre.

The force holding the modules together may be provided by other means, for example it may be electromagnetic, provided by a vacuum or mechanical (for example snap fit). In each case, there will be a resultant vector of the force experienced by the modules. FIG. 17 illustrates a modular probe in which the modules are releasably coupled using a mechanical releasable connection. The task module has a connection pin 80 protruding from its upper surface. The retaining module has an aperture 82 in its lower surface leading to a recess 84 within the housing, in which a receptacle 86 is provided. When the modules are coupled together, the connection pin 80 of the task module is inserted into the receptacle 86 of the retaining module. In this example, the connection pin has a head 88 of increased diameter and the receptacle comprises two balls 90 mounted on resilient supports 92. The resilience of the supports enables the balls to deflect around the head of increased diameter and hold the connection pin beneath the head.

The task module 18 is provided with an engagement feature, comprising an elongate aperture 40 which is nominally parallel to the top face 24 of the task module and thus generally transverse to the resultant coupling force between the task module and the retaining module. When the engagement member is inserted into the aperture it passes up to or beyond the resultant vector of the coupling force between the task module and the retaining module, which in this embodiment is along the centre line 42 of the task module. By configuring the engagement member so that it extends up to or beyond the resultant vector of the coupling force, it is ensured that the elongate member does not have any tilting or lever action during the step of separation or connection of the modules, as the resultant attractive force acts through the elongate member without causing a moment. For optimum results, the engagement member intercepts the position of the resultant vector of the coupling force.

In use, the modular probe is moved relative to the table of the machine by the quill, which is powered by movement by the X,Y and Z motors of the machine. The task module is placed in a storage port by positioning the modular probe such that the elongate member lines up with the elongate aperture in the task module. The modular probe is moved horizontally by the machine until the engagement member is inserted into the aperture of the task module. FIG. 2 illustrates the modular probe 14 positioned such that the elongate portion of the member 38 is aligned with the aperture 40 in the task module 18. FIG. 3 illustrates the probe 14 positioned such that the task module 18 is located in the storage port 32, with the elongate member 38 inserted in the aperture 40 of the task module 18.

To separate the modules, the quill 12 of the machine is moved upwards, pulling the retaining module 16 upwards. The task module 18 is restrained by the elongate member 38 inserted into the aperture 40, thus causing the magnetic connection between the two modules to be broken, thereby separating the modules. FIG. 4 illustrates the retaining module 16 being pulled upwards by the quill 12 of the machine as the two modules are separated.

Likewise, to pick up a task module 18, the machine moves the quill 12 and retaining module 16 to a position vertically above the task module 18, until the faces 24,26 and engagement elements 20,22 of the retaining module 16 and task module 18 are aligned.

The quill and retaining module are moved down vertically so that the engagement elements 20,22 of the two modules are in engagement, the two modules being held in engagement by magnetic attraction. The quill is then moved horizontally to move the retaining module and the task module now coupled with it away from the storage port, thereby disengaging the task module from the engagement member.

The use of a single elongate member which engages with a feature such as an aperture in the task module has the advantage that the storage port and a magazine made of multiple storage ports can be made more compact. FIG. 15A illustrates a plan view of a prior art magazine 70 of storage ports 72, as described in EP 0566719. FIG. 15B illustrates a magazine 74 of storage ports according to the present invention in which task modules are supported on engagement members 38. The magazine 74 illustrated in FIG. 15B enables the task modules to be stored in a more compact arrangement. FIG. 16 is a plan view of a magazine comprising a low volume carousel 76 in which multiple engagement members 38 are distributed radially around a central support 78, thereby enabling multiple task modules to be stored in a compact arrangement. This is particularly suitable for machines with a low working volume, such as a vision machine.

The use of a single elongate member also has the advantage that it provides a simple storage port which is cheap to manufacture.

The use of a single elongate member inserted through an aperture in the task module has the advantage that tilting of the task module relative to the retaining module due to mechanical tolerance of the storage port is reduced during separation and connection of the modules.

By use of a single elongate member, the task module can rotate about the longitudinal axis, thereby enabling it to remain square to the retaining module. If there is sufficient gap between the diameters of the elongate member and aperture, some rotation about an axis which is horizontal and perpendicular to the longitudinal axis is also possible. This can be further improved by limiting the contact between the elongate member and task module to a small area or point aligned with the position of the resultant force vector (which may be aligned with the centre line of the task module) during engagement and pull-off of the task module.

The small area or point of contact is achieved by modifying the basic arrangement illustrated in FIGS. 2-4.

In the embodiment illustrated in FIG. 5, the aperture of the task module is provided with a protrusion on its lower surface, aligned with the centre line of the task module. When the task module is engaged with the engagement member and the modules are being pulled apart the engagement member will be in contact with the protrusion, thereby ensuring that the force from the upwards motion of the retaining module is aligned with the centre line of the task module.

Conversely, a protrusion may be provided on the top surface of the engagement member, such that when the engagement member and task module are engaged, the protrusion is aligned with the centre line of the task module. Protrusions may be located on both the task module and engagement member, such that the protrusions are aligned with one another, when the engagement member and task module are engaged.

FIG. 6 illustrates the protrusion on the underside of the engagement member and FIG. 7 illustrates protrusions on both the aperture of the task module and the engagement member.

The protrusion in the embodiments of FIGS. 5-7 may be positioned so that they are in alignment with the position of the resultant attractive force. This has the benefit that the resultant attractive force acts through the one or more protrusions and the task module can rotate about the protrusion, ensuring that it remains square to the retaining module. Whereas without the protrusion, the task module could rotate about the longitudinal axis of the elongate member, the task module can now also rotate about an axis which is horizontal and perpendicular to the longitudinal axis of the elongate member.

The task module is preferably positioned so that the protrusion on the elongate member is aligned with the resultant force vector. This may be achieved simply by using the motors of the machine to move the quill to the X,Y,Z coordinates to achieve this aim. Alternatively, a mechanical stop may be provided on the storage port, positioned such that when the task module is inserted into the storage port and abuts the mechanical stop, it is correctly positioned.

In the embodiment illustrated in FIG. 8, the engagement member has a round cross section, with the aperture of the task module also having a round cross section, the inner diameter of the aperture being slightly larger than the outer diameter of the engagement member. With this arrangement, the task module can rotate about the central axis of the elongate member. This has the advantage that when task module is being pulled off or engaged with the retaining module, the task module can rotate until it is aligned with the retaining module. Whilst, the task module can rotate, the position of the aperture in the task module is preferably such that the centre of gravity is below the aperture, so that the task module keeps its position.

Retaining means may also be provided on the storage port, to prevent the task module from rotating beyond an allowable amount. FIGS. 8&9 show a first type of retaining means, which comprises a U shaped mount 50. When the task module is held in the storage port, the engagement member supports the task module, without contact between the task module and the U-shaped support, as illustrated in FIG. 8. However, if the task module rotates beyond a predetermined amount, the mount 50 will act as a stop, making contact with the task module and preventing further rotation, as illustrated in FIG. 9.

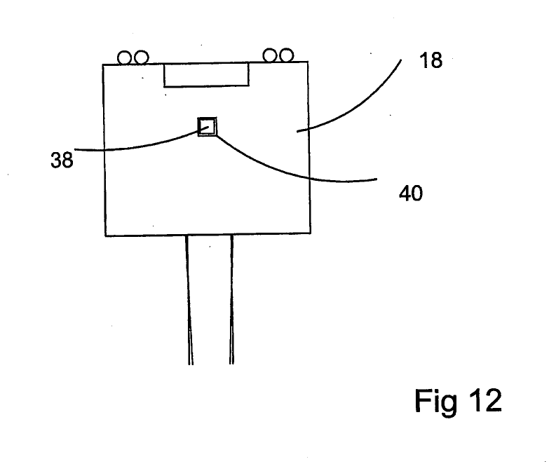

Alternatively, a second type of retaining means may comprise a fork shaped support 52 as illustrated in FIGS. 10 and 11. The fork shaped support 52 is located on the support 36 of the storage port, such that when a task module is held in the storage port, it has one prong extending on either side of the stylus. As before, there is no contact between the fork and the stylus when the task module is in the upright position, as illustrated in FIG. 10, but on rotation beyond a certain amount, the fork prongs will act as a stop, preventing further rotation of the task module, as illustrated in FIG. 11.

These retaining means enable the aperture to be located below the centre of gravity in the task module, for example the aperture may be located in the stylus.

The engagement means and the aperture of the task module may be shaped to provide a key between the two. For example, FIG. 12 shows both the engagement means 38 and the aperture 40 with square cross sections. In this case, the relative dimensions of the engagement means and aperture is such that the engagement means can be inserted into the aperture and a limited amount of rotation is possible. In this embodiment, additional restraint members to act as stops are not required as the keying between the aperture and the elongate member limits rotations.

A further embodiment is illustrated in FIG. 13. In this embodiment, the engagement member 38 has a forked engagement region 54, for engagement with the task module. FIG. 13 also illustrates a task module 18 suitable for engagement with forked engagement region. The task module is provided with an annular recess 57, into which the fork can engage. Alternatively, the task module could be provided with two linear recesses or apertures for engagement with the forked engagement region or a flange such as a circular lip to engage with the forked region.

The forked engagement region is rotatably mounted so that is can rotate about its longitudinal axis. FIG. 13 illustrates a mount region 58 of the engagement region for mounting on the support, a forked engagement region 54 and a bearing between them to enable the forked engagement region to rotate relative to the mount region about the longitudinal axis 56. This arrangement enables the task module engaged with the forked engagement region to rotate and thereby ensure correct alignment as the modules are either being connected or disconnected.

Reference has been made in the above-described embodiments of the invention to a task module or stylus module. It should be appreciated that the invention is not limited to stylus modules of the type disclosed in EP 0566719, in which a stylus is deflectably mounted in an housing of the stylus module. The above embodiments are equally applicable to simple, exchangeable styli or other tools for a metrological probe.

Although the engagement member of the storage port or storage device has been illustrated extending completely through and beyond the task module of the probe, this is not essential. It may extend only partially through it. The receiving aperture in the task module may then be a blind hole, rather than extending completely through it.

It should also be appreciated that in a modular probe, the sensor for detecting contact between the stylus and a workpiece may be located either in the stylus or task module, or in the retaining module. As is well known, it may comprise an electrical circuit through kinematic engagement elements on which the stylus is mounted, or other sensors such as strain gauges.

Furthermore, where reference is made herein to horizontal and vertical directions, e.g. to horizontally-extending elements or to vertical movements, it is to be understood that these are intended as nominal or approximate directions, not necessarily absolutely horizontal or vertical.

1. A storage device for separating and/or connecting a releasably coupled task module or tool from/to a probe or retaining module of a probe, the task module or tool being releasably coupled to the retaining module or probe by a resultant coupling force between them, the task module or tool having at least one elongate receiving aperture which is generally transverse to the resultant coupling force, the storage device comprising:
at least one elongate engagement member which is generally transverse to the resultant coupling force, for engagement in the at least one receiving aperture of the task module or tool, the engagement member being dimensioned to extend substantially up to or beyond the resultant vector of the coupling force between the task module or tool and the probe or retaining module when the engagement member is engaged with the at least one receiving feature.

2. A storage device according to claim 1, comprising a single said elongate engagement member.

3. A storage device according to claim 1 or claim 2 wherein the engagement member is dimensioned to intersect with the position of the resultant vector when the engagement member is engaged with the at least one receiving aperture.

4. A storage device according to any preceding claim wherein the engagement member includes a protrusion on its surface.

5. A storage device according to claim 4 wherein the engagement member is configured such that the resultant vector acts through the protrusion, when the engagement member is engaged with the at least one receiving aperture.

6. A storage device according to any preceding claim wherein the engagement member has a longitudinal axis and is configured to enable at least limited rotation of the task module about the longitudinal axis when the engagement member is engaged with the at least one receiving aperture.

7. A storage device according to any preceding claim wherein the engagement member has a longitudinal axis and is configured to enable at least limited rotation of the task module about an axis which is horizontal and perpendicular to the longitudinal axis when the engagement member is engaged with the at least one receiving aperture.

8. A storage device according to any preceding claim wherein the storage device further comprises at least one retaining means to limit rotation of the task module about the longitudinal axis of the engagement member when the at least one engagement portion is engaged with the task module.

9. A storage device according to claim 8 wherein the at least one retaining means comprises at least one mechanical stop.

10. A storage device according to claim 8 wherein the at least one retaining means comprises the configuration of the engagement member.

11. A magazine comprising at least one storage device, the storage device having the features according to any of claims 1-10.

12. A task module or tool suitable for releasably coupling to a probe or retaining module of a probe, the task module or tool comprising
at least one coupling element for engaging with at least one corresponding coupling element on the probe or retaining module to provide releasable coupling between the task module or tool and the probe or retaining module, the coupling producing a resultant force between them;
at least one receiving aperture in the housing for engaging with an engagement element of a storage device, whereby the at least one receiving aperture extends up to or beyond the vector of the resultant force when the engagement member is engaged with the at least one receiving aperture.

13. A task module according to any of claim 11 or 12 wherein the at least one receiving aperture includes a protrusion which is aligned with the resultant attractive force.

14. A storage device for separating and/or connecting a releasably coupled task module from a modular probe, the task module having at least one receiving feature, the storage device comprising:
an engagement member, having a longitudinal axis and at least one engagement portion for engagement with at least one receiving feature of the task module;
whereby the at least one engagement portion is configured to enable at least limited rotation of the task module about at least one of the longitudinal axis and an axis which is horizontal and perpendicular to the longitudinal axis, then the at least one engagement portion is engaged with the at least one receiving feature.

15. A storage device according to claim 14 wherein the engagement member includes a protrusion on its surface.

16. A storage device according to any of claim 14 or 15 wherein the storage device further comprises at least one retaining means to limit rotation of the task module about the longitudinal axis of the engagement member when the at least one engagement portion is engaged with the task module.

17. A storage device according to claim 16 wherein the at least one retaining means comprises at least one mechanical stop.

18. A magazine comprising at least one storage device, the storage device having the features according to any of claims 14-17.

19. A storage device for separating and/or connecting a releasably coupled task module or tool from/to a probe or retaining module of a probe, the task module or tool being releasably coupled to the retaining module or probe by a resultant coupling force between them, the task module or tool having at least one receiving feature, the storage device comprising:
at least one elongate engagement member for engagement with the at least one receiving feature of the task module or tool, the engagement member being dimensioned to extend substantially up to or beyond the resultant vector of the coupling force between the task module and the modular probe when the engagement member is engaged with the at least one receiving feature.

20. A task module or tool suitable for releasably coupling to a probe or retaining module of a probe, the task module or tool comprising
at least one coupling element for engaging with at least one corresponding coupling element on the probe or retaining module to provide releasable coupling between the task module or tool and the probe or retaining module, the coupling producing a resultant force between them;
at least one receiving feature in the housing for engaging with an engagement element of a storage device, whereby the at least one receiving feature extends up to or beyond the vector of the resultant force when the engagement member is engaged with the at least one receiving feature.
